(19) United States
(12) Patent Application Publication
(10) Pub. No.: US 2024/0385147 A1
(43) Pub. Date: Nov. 21, 2024

(54) ACCELERATED DEGRADATION TESTING DEVICE

(71) Applicant: SHIMADZU CORPORATION

(72) Inventors: Yukinori HASEGAWA, Kyoto-shi (JP); Kenichi KITAMURA, Kyoto-shi (JP)

(21) Appl. No.: 18/691,402

(22) PCT Filed: Jun. 27, 2022
(86) PCT No.: PCT/JP2022/025588

§ 371 Date: Mar. 12, 2024

(30) Foreign Application Priority Data
Sep. 28, 2021 (JP) 2021-157989

(51) Int. Cl. G01N 30/06; B01D 53/02; G01N 30/02

(52) U.S. Cl. CPC G01N 30/06; B01D 53/025; G01N 2030/025

(57) ABSTRACT

An accelerated degradation testing device is used for an accelerated degradation test in which degradation of a sample is accelerated by means of multiple degradation factors, and is provided with a hermetically sealed container capable of accommodating a sample as a target of the accelerated degradation test, and a container holder for holding the hermetically sealed container. The accelerated degradation testing device is configured to conduct the accelerated degradation test of the sample accommodated in the hermetically sealed container in a state in which the sample is accommodated together with a liquid as one of degradation factors in the hermetically sealed container.

### TECHNICAL FIELD

The present invention relates to an accelerated degradation testing device.

### BACKGROUND ART

Conventionally, a combined cycle testing device is known in which corrosion resistance of various materials is evaluated by combining multiple types of test conditions (environmental tests). For example, such a combined cycle testing device is disclosed in Japanese Unexamined Patent Application Publication No. 2018-132385.

In the combined cycle testing device described in the above-described Japanese Unexamined Patent Application Publication No. 2018-132385, a test is conducted in which degradation of various materials is accelerated in a test chamber while changing degradation factors (degradation loads) such as a temperature and humidity. Further, in a conventional combined cycle test device, such as the one described in Japanese Unexamined Patent Application Publication No. 2018-132385, a test that accelerates liquid-induced degradation of various materials is conducted by spraying (“blowing”) a liquid such as salt water (corrosive liquid) against a sample.

### PRIOR ART DOCUMENT

### Patent Document

Patent Document 1: Japanese Unexamined Patent Application Publication No. 2018-132385

### SUMMARY OF THE INVENTION

### Problems to be Solved by the Invention

However, in a conventional combined cycle testing device, as described in Japanese Unexamined Patent Application Publication No. 2018-132385, in the case of spraying a liquid (corrosive liquid) such as salt water against a sample while changing degradation factors (degradation loads) such as a temperature and humidity, in addition to the adjustment of the temperature and the humidity in the test chamber, it is necessary to adjust the test environment (environment in the test chamber) for spraying the liquid, such as controlling the air circulation. Therefore, in an accelerated degradation test that accelerates degradation of a sample by means of multiple degradation factors, there is a problem that the degradation by means of a liquid (in a solution environment) cannot be easily enhanced (accelerated).

The present invention has been made to solve the above-described problems, and one object of the present invention is to provide an accelerated degradation testing device, for an accelerated degradation test in which degradation of a sample is accelerated by means of multiple degradation factors, capable of easily accelerating degradation of a sample by means of a liquid (in a solution environment).

### Means for Solving the Problems

The accelerated degradation testing device according to one aspect of the present invention is an accelerated degradation testing device for an accelerated degradation test in which degradation of a sample as a test target is accelerated by means of multiple degradation factors that degrade the sample. The accelerated degradation testing device includes:
a hermetically sealed container capable of accommodating the sample as a target of the accelerated degradation test in a hermetically sealed state; and
a container holder configured to hold the hermetically sealed container,
wherein the accelerated degradation test of the sample accommodated in the hermetically sealed container in a hermetically sealed state is conducted in a state in which the sample is accommodated in the hermetically sealed container together with a liquid as one of the degradation factors.

### Effects of the Invention

The accelerated degradation testing device according to one aspect of the present invention is configured to conduct an accelerated degradation test of a sample accommodated in a hermetically sealed container in a hermetically sealed state together with a liquid as one degradation factor in the hermetically sealed container. With this, in an accelerated degradation test in which degradation of a sample is accelerated by means of multiple degradation factors, it is possible to conduct the test in a state in which a sample is in contact with a liquid in a hermetically sealed container by accommodating a liquid as one degradation factor together with the sample in the hermetically sealed container. As a result, unlike the case of spraying a liquid against a sample, it is not necessary to adjust the test environment to accelerate the degradation by means of the liquid, and therefore, it is possible to easily accelerate the degradation by means of the liquid. With this, in the accelerated degradation test in which degradation of a sample is accelerated by means of multiple degradation factors, it is possible to easily accelerate degradation by means of the liquid (in a solution environment).

### BRIEF DESCRIPTION OF THE DRAWINGS

FIG. 1 is a schematic diagram showing the overall configuration of an accelerated degradation testing device according to one embodiment of the present invention.

FIG. 2 is a perspective diagram showing the appearance of the accelerated degradation testing device.

FIG. 3 is a perspective view showing the accelerated degradation testing device with the door open.

FIG. 4 is a perspective view of the accelerated degradation testing device with the container holder pulled out.

FIG. 5 is a cross-sectional view taken along the line 500-500 in FIG. 2.

FIG. 6 is an external view of the hermetically sealed container.

FIG. 7 is a cross-sectional view of the hermetically sealed container taken along the line 600-600 in FIG. 6.

FIG. 8 is a perspective cross-sectional view of the hermetically sealed container taken along the line 600-600 in FIG. 6.

FIG. 9 is a cross-sectional view of the hermetically sealed container taken along the line 700-700 in FIG. 6.

FIG. 10 is a partially enlarged view of the container holder and therearound in FIG. 5.

FIG. 11 is a cross-sectional view taken along the line 800-800 in FIG. 10.

FIG. 12 is a cross-sectional view taken along the line 900-900 in FIG. 11.

FIG. 13 is a perspective cross-sectional view taken along the line 900-900 in FIG. 11.

### EMBODIMENTS FOR CARRYING OUT THE INVENTION

Hereinafter, some embodiments in which the present invention is embodied will be described based on the attached drawings.

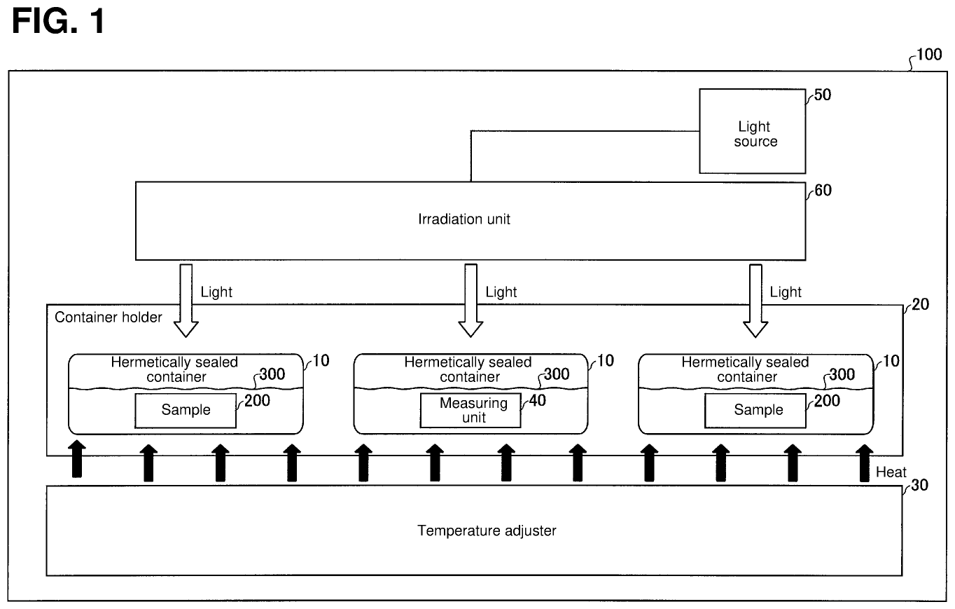

Referring to FIG. 1 to FIG. 13, the configuration of the accelerated degradation testing device 100 according to this embodiment will be described.

### (Configuration of Accelerated Degradation Testing Device)

The accelerated degradation testing device 100 is a device for conducting an accelerated degradation test (degradation acceleration) that enhances (accelerates) degradation of a sample 200. The accelerated degradation testing device 100 is a device used primarily in a material exploration and a trial production stage of a material development process. The sample 200 as a test target by the accelerated degradation testing device 100 includes a material (e.g., resin, fiber, metal, and wood), paint, a component for a transportation machine, food grade oil, food grade packaging, and a food product. Further, the accelerated degradation testing device 100 is a relatively compact device capable of being installed in a laboratory.

As shown in FIG. 1, the accelerated degradation testing device 100 is provided with hermetically sealed containers 10 each capable of accommodating a sample 200 to be subjected to an accelerated degradation test, and a container holder 20 for holding the hermetically sealed containers 10.

Further, the accelerated degradation testing device 100 is equipped with a temperature adjuster 30 for adjusting the temperature as one of degradation factors and a measuring unit 40 for measuring the environment including the temperature in the hermetically sealed container 10. Note that the measuring unit 40 is one example of the “container internal environment measuring unit” as recited in claims.

Further, the accelerated degradation testing device 100 is equipped with a light source 50 for emitting light as a degradation factor and an irradiation unit 60 for emitting (outgoing) the light emitted from the light source 50 as one of degradation factors. In this embodiment, the light source 50 is configured to emit light including ultraviolet (UV) light. The light source 50 includes, for example, a UV light source that emits ultraviolet (UV) light. Note that the light source 50 may include a xenon light source including a xenon lamp. In other words, the light source 50 may be a light source that emits light in a wavelength range other than the wavelength range of ultraviolet (UV) light. Further, the light source 50 may be a light source that emits infrared light.

The accelerated degradation testing device 100 in this embodiment is configured to conduct an accelerated degradation test of a sample 200 accommodated in the hermetically sealed container 10 in a hermetically sealed state in a state in which the sample 200 is accommodated together with a liquid 300 as one of degradation factors in the hermetically sealed container 10.

Specifically, the accelerated degradation testing device 100 is configured to conduct an accelerated degradation test on a sample 200 by adjusting the temperature and the light irradiation in a state in which the sample 200 is accommodated together with a liquid 300 as one of degradation factors in the hermetically sealed container 10. In other words, the accelerated degradation testing device 100 is a composite accelerated degradation testing device capable of conducting an accelerated degradation test while simultaneously adjusting multiple degradation factors (while applying multiple degradation loads). With this, it is possible to conduct an accelerated degradation test (degradation accelerating test) under the condition more similar to the actual exposure environment (under the actual exposure environment).

Further, the liquid 300 to be accommodated in the hermetically sealed container 10 together with the sample 200 is, for example, an acidic liquid, salt water, and water. In cases where an acidic liquid is used as the liquid 300, it is possible to conduct a test (accelerated degradation test) of the sample 200 against acid rain and acids such as acidic chemicals. In the case of using salt water as the liquid 300, it is possible to conduct a test (accelerated degradation test) of the sample 200 against seawater and sea breezes. Further, in the case of using water as the liquid 300, it is possible to conduct a test (accelerated degradation test) related to water resistance. Further, the humidity in the hermetically sealed container 10 can be adjusted by the water accommodated in the hermetically sealed container 10. The humidity in the hermetically sealed container 10 can be changed based on the saturated water vapor content.

That is, the hermetically sealed container 10 is configured to accommodate, in a hermetically sealed state, a sample 200 to be subjected to an accelerated degradation test in which degradation of the sample 200 is accelerated by multiple degradation factors (temperature, light, liquid 300, and humidity) that degrades the sample 200 as a test target. Note that in the accelerated degradation testing device 100, it is possible to conduct an accelerated degradation test using at least one of temperature and light as the degradation factor (degradation load) without accommodating the liquid 300 in the hermetically sealed container 10.

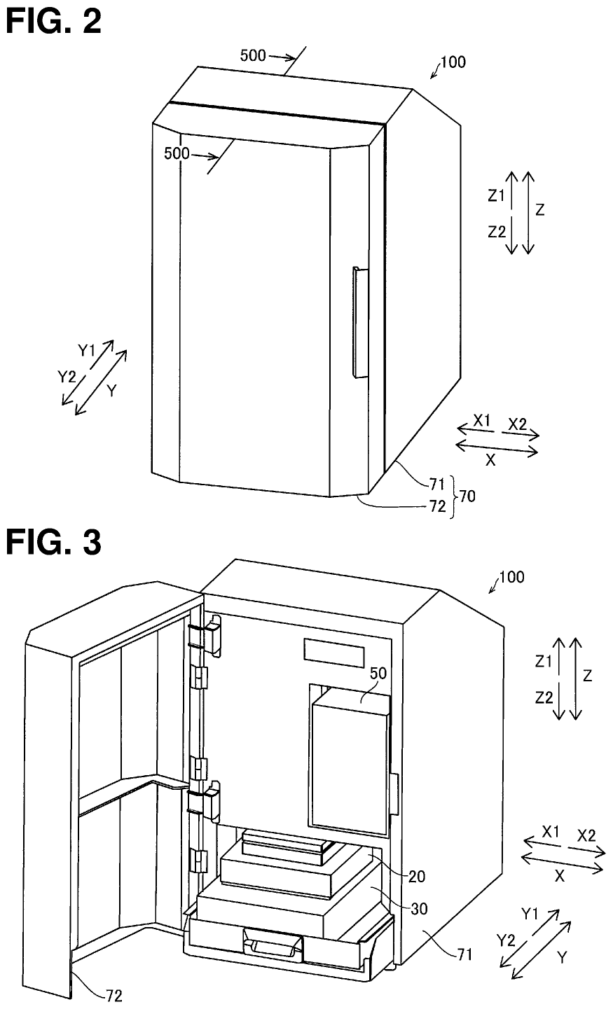

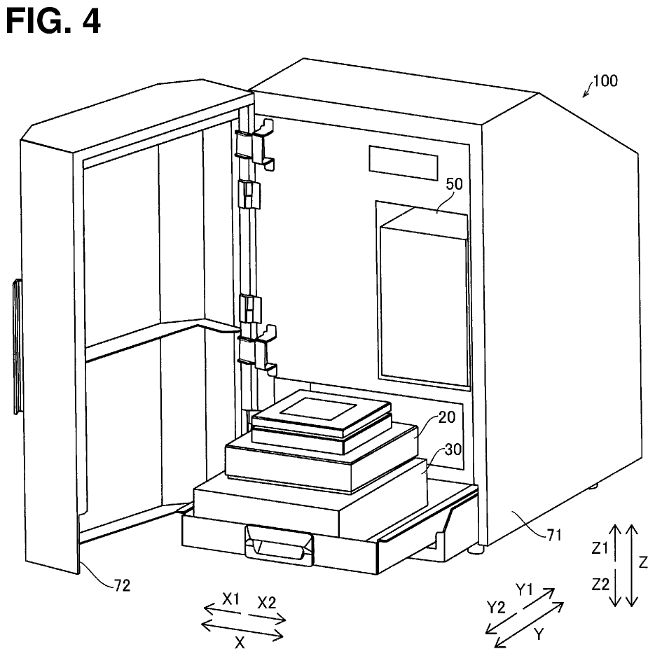

Further, the accelerated degradation testing device 100 is equipped with, as shown in FIG. 2 and FIG. 3, a housing 70 including a main body 71 and a door 72 attached to the main body 71 in an openable and closeable manner. The container holder 20, the temperature adjuster 30, the light source 50, and the irradiation unit 60 are arranged in the main body 71. The accelerated degradation testing device 100 is configured (see FIG. 4) such that the container holder 20 and the temperature adjuster 30 can be moved (taken out) (see FIG. 4) in the forward direction (Y2-direction) with the door 72 open. When conducting an accelerated degradation test, the container holder 20 is arranged in the main body 71 in a state in which the container holder 20 holds the hermetically sealed container 10 in which the sample 200 is accommodated.

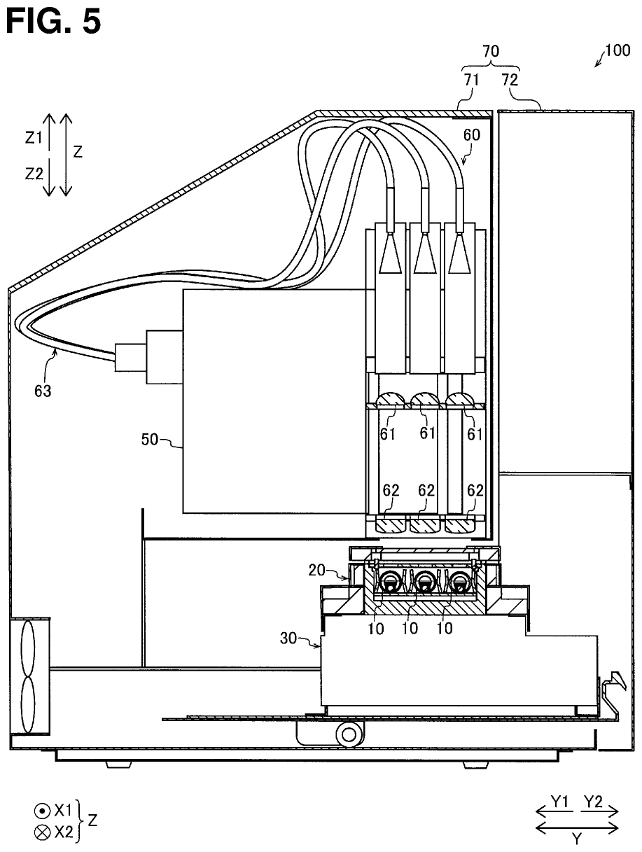

Further, in the main body 71, as shown in FIG. 5, the temperature adjuster 30 and the irradiation unit 60 are arranged so as to sandwich the container holder 20 in the vertical direction (Z-direction). Specifically, the light source 50 and the irradiation unit 60 are arranged on the upper side (Z1-direction side) of the container holder 20, and the temperature adjuster 30 is arranged on the lower side (Z2-direction side) of the container holder 20. In the accelerated degradation testing device 100, the container holder 20 is configured to be placed on the top surface of the temperature adjuster 30. The temperature adjuster 30 is configured to raise the temperature of the air surrounding the hermetically sealed container 10. The temperature adjuster 30 includes, for example, a hot plate.

The temperature adjuster 30 is configured such that the user can change the temperature setting, etc., by operating the control unit, which is not illustrated in the figure. Further, the light source 50 is configured such that the user can change the intensity of the emitted light, etc., by operating the control unit, which is not illustrated in the figure. In other words, in the accelerated degradation testing device 100, the user performs the adjustment of the temperature by the temperature adjuster 30 and the adjustment of the light emitted from the light source 50 (light emitted from the irradiation unit 60). Note that it may be configured such that a control board for adjusting the temperature by the temperature adjuster 30 and the light emitted from the light source 50 is provided in the housing 70 to collectively control them. Further, the accelerated degradation testing device 100 may be communicatively connected to a personal computer (PC) outside the device, and the adjustment of the temperature by the temperature adjuster 30 and the adjustment of the light emitted from the light source 50 may be conducted by the PC outside the device.

Further, as shown in FIG. 5, a plurality (three) of sealed containers 10 is provided. The irradiation unit 60 is configured to branch the light emitted from the light source 50 and irradiate each of the samples 200 in the plurality of hermetically sealed containers 10 held by the container holder 20 with the light.

The irradiation unit 60 includes a lens 61 and a lens 62. Each of the lenses 61 and 62 is provided by the same number as the number of the hermetically sealed containers 10 that can be held by the container holder 20. In this embodiment, the container holder 20 can hold three hermetically sealed containers 10, and the lens 61 and the lens 62 are each composed of three lenses. Further, the irradiation unit 60 includes a light guide 63. The light guide 63 includes an optical fiber and is configured to guide the light emitted from the light source 50. Further, one end of the light guide 63 is connected to the light source 50, and the other end thereof is divided into three. The light emitted from the light source 50 is split into three by the light guide 63, and each split light enters the lens 62 through each of the plurality (three) of lenses 61. Note that the lens 62 is one example of the “diaphragm” as recited in claims.

### (Configuration of Hermetically Sealed Container)

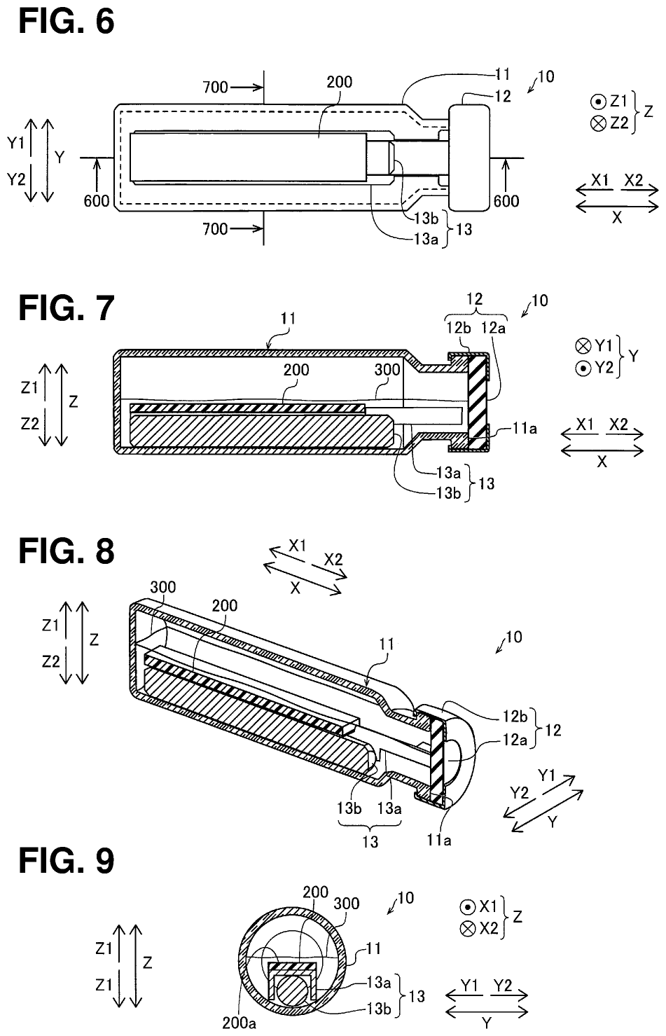

As shown in FIG. 6 to FIG. 9, the hermetically sealed container 10 includes a bottle-shaped container body 11 in which the sample 200 is accommodated and a lid 12 for hermetically sealing the container body 11 in a state in which the sample 200 is accommodated in the container body 11. Note that the container body 11 is a translucent member. Note that the lid 12 is one example of the “sealing portion” as recited in claims. Note that the hermetically sealed container 10 is a sampling container (vial) used for an analysis by a gas chromatograph analyzer. With this, the hermetically sealed container 10 can be used as it is for an analysis by a gas chromatograph analyzer, and therefore, an analysis by a gas chromatograph analyzer can be easily conducted on the sample 200 after and during the accelerated degradation test (in the process of degradation).

The container body 11 is made of, for example, quartz glass or borosilicate glass. Further, the lid 12 is a cap with a septum 12a, which can be used for an auto-sampler. Specifically, as shown in FIG. 7 and FIG. 8, the lid 12 includes a septum 12a and an aluminum cap 12b and is configured to hermetically seal the container body 11. The septum 12a is configured to seal the mouth portion 11a (the end face of the container body 11 in the X2-direction) of the container body 11. The septum 12a contains, for example, PTFE (Poly Tetra Fluoro Ethylene), rubber, silicone rubber, or polyethylene. The aluminum cap 12b is configured to tighten the septum 12a and the container body 11 with the container body 11 and the mouth portion 11a of the container body 11 covered by the septum 12a. In other words, the aluminum cap 12b is used as an aluminum caulk. Further, the aluminum cap 12b is configured to expose the center of the septum 12a, as shown in FIG. 7 and FIG. 8. Therefore, in the hermetically sealed container 10 (lid 12) according to this embodiment, sampling by the auto-sampler can be conducted without removing the aluminum cap 12b by penetrating a syringe needle (needle) of an auto-sampler through the portion where the septum 12a is exposed. Further, the hermetically sealed container 10 may be configured to hermetically seal the container body 11 by a twist cap or a screw cap lid 12 by providing a thread on the container body 11.

A sample support 13 for supporting the sample 200 in the hermetically sealed container 10 is provided (accommodated) in the hermetically sealed container 10. The sample support 13 includes a support plate 13a for supporting the sample 200 and a magnetic rod 13b. Note that the magnetic rod 13b is one example of the “ferromagnetic member” as recited in claims. The magnetic rod 13b is a bar-shaped metallic member with ferromagnetic properties. The magnetic rod 13b is made of, for example, stainless alloy steel containing chromium (Cr) such as SUS430. The magnetic rod 13b may be plated depending on the liquid 300 accommodated in the hermetically sealed container 10 and substances generated by the degradation (reaction) of the sample 200.

Further, as shown in FIG. 9, the support plate 13a has a convex U-shape protruding on the Z1-direction side (irradiation unit 60) when viewed from the X1-direction side. The support plate 13a is arranged to surround the magnetic rod 13b in three directions (Z1-direction side, Y1-direction side, and Y2-direction side) and is configured to hold the magnetic rod 13b.

Further, in this embodiment, the sample support 13 is configured to support the sample 200 in the hermetically sealed container 10 and is configured to be taken out of the inside of the hermetically sealed container 10. Specifically, the sample support 13 can be taken out of the container body 11 of the hermetically sealed container 10 in the X2-direction by removing the lid 12.

### (Configuration of Container Holder)

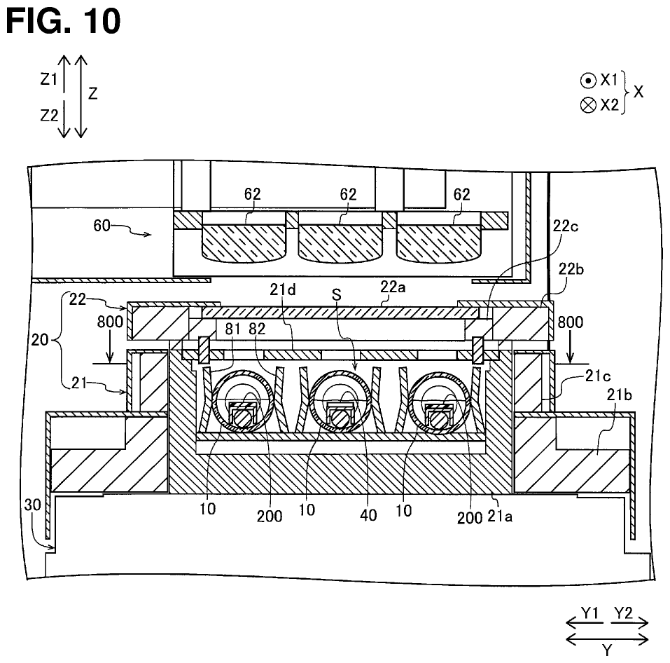

As shown in FIG. 10, the container holder 20 includes an accommodation unit 21 that accommodates the hermetically sealed containers 10. Further, the container holder 20 includes a cover 22 that covers the accommodation unit 21 from above (Z1-direction side). The accommodation unit 21 includes an aluminum block 21a placed on the top surface of the temperature adjuster 30. On the outer circumference of the aluminum block 21a, insulation materials 21b and 21c to insulate the interior space S formed by the accommodation unit 21 and the cover 22. Further, the accommodation unit 21 includes a slit plate 21d arranged above the aluminum block 21a. The slit plate 21d is provided with a plurality (three) of slits corresponding to the plurality (three) of hermetically sealed containers 10. Further, the cover 22 is provided with a quartz plate (quartz glass) 22a, which is a plate-shaped translucent member, to allow the light (UV light) emitted from the irradiation unit 60 to penetrate through the accommodation unit 21. This allows the light (UV light) emitted from the irradiation unit 60 to irradiate the interior space S formed by the accommodation unit 21 and the cover 22 with the light. Further, the cover 22 is provided with insulation members 22b and 22c to insulate the interior space S.

And the lens 62 of the irradiation unit 60 is configured to narrow the light irradiation region to correspond to the location of the sample 200 in the hermetically sealed container 10. Specifically, the irradiation region of the light guided from the light source 50 is narrowed down so that the irradiation region becomes approximately a rectangular shape long in the X-direction in accordance with the shape of the support plate 13a for supporting the sample 200. On the support plate 13a, for example, a sample 200 with a length of about 10 mm in the Y-direction and a length of about several tens of millimeters in the X-direction can be placed.

In this embodiment, the accelerated degradation testing device 100 is configured to conduct an accelerated degradation test of the sample 200 accommodated in the hermetically sealed container 10 in a hermetically sealed state by irradiating the sample 200 with the light emitted from the irradiation unit 60 through the container body 11, which is a light-permeable member. Specifically, the light guided from the light source 50 and emitted from the irradiation unit 60 is emitted through the quartz plate 22a and the container body 11 to irradiate the sample 200, which enhances (accelerates) degradation of the sample 200 due to the light (UV light).

In this embodiment, the accelerated degradation testing device 100 is configured to conduct an accelerated degradation test of the sample 200, which is hermetically sealed within the hermitically sealed container 10, by adjusting the temperature by the temperature adjuster 30 with the sample 200 accommodated in the hermetically sealed state within the hermetically sealed container 10. Specifically, the temperature adjuster 30 raises the temperature in the hermetically sealed container 10 by heating the air in the interior space S formed by the accommodation unit 21 and the cover 22 via the aluminum block 21a of the accommodation unit 21. The temperature inside the hermetically sealed container 10 is raised, which enhances (accelerates) the temperature (heat)-induced degradation of the sample 200.

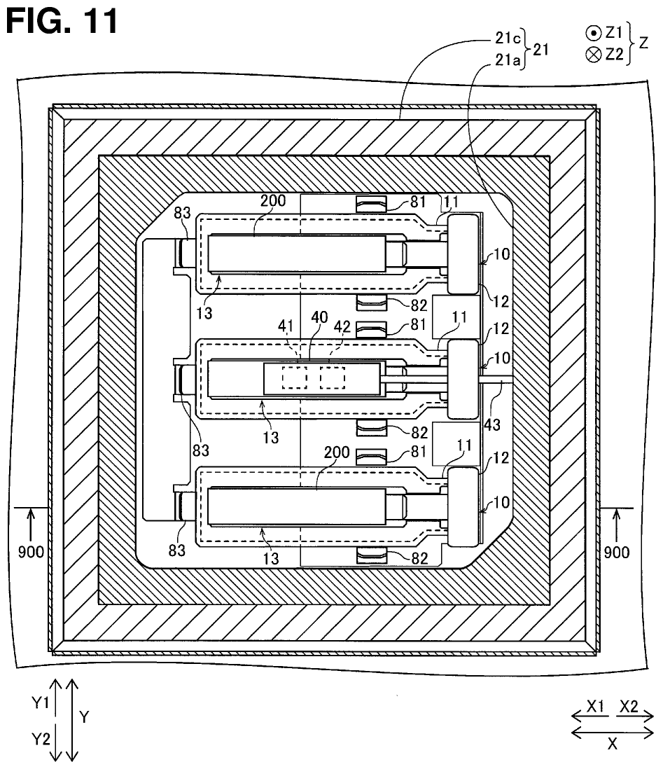

As shown in FIG. 10 and FIG. 11, in the container holder 20, a hermetically sealed container 10 in which the sample 200 is accommodated in a hermetically sealed state and a hermetically sealed container 10 in which the measuring unit 40 is accommodated in place of the sample 200 in a hermetically sealed state are held.

The measuring unit 40 includes a temperature sensor 41 (see FIG. 11) accommodated in the hermetically sealed container 10 in a hermetically sealed state. Further, the measuring unit 40 includes a humidity sensor 42 (see FIG. 11). In other words, the measuring unit 40 can measure the temperature and the humidity. Note that the temperature sensor 41 and the humidity sensor 42 may be integrally constituted. Further, the measuring unit 40 may include various sensors, such as an illuminance sensor, for measuring the environment in the hermetically sealed container 10.

Further, as shown in FIG. 11, the container holder 20 is configured to hold the hermetically sealed container 10 in which the sample 200 is accommodated in a hermetically sealed state and a hermetically sealed container 10 in which the measuring unit 40 (temperature sensor 41) is accommodated in place of the sample 200 in a hermetically sealed state. In other words, the container holder 20 is configured to hold a reference hermetically sealed container 10 in which the measuring unit 40 is accommodated.

Further, as shown in FIG. 11, the container holder 20 (accommodation unit 21) is configured to accommodate a plurality (two) of hermetically sealed containers 10 in which the sample 200 is accommodated in a hermetically sealed state and a hermetically sealed container 10 in which the measuring unit 40 (temperature sensor 41) is accommodated in the accommodation unit 21 in place of the sample 200 in a hermetically sealed state. The hermetically sealed container 10 in which the measuring unit 40 is accommodated is arranged at the position between the two hermetically sealed containers 10 accommodating the sample 200 in the Y-direction (front-back direction). The hermetically sealed container 10 accommodating the measuring unit 40 is arranged in the central portion in the accommodation unit 21 in the X-direction (left-right direction) and the Y-direction (front-back direction). Note that the hermetically sealed container 10 accommodating the measuring unit 40 may be arranged (held) at a location within the accommodation unit 21 other than the center portion in the X-direction (left-right direction) and the Y-direction (front-back direction).

The container holder 20 (accommodation unit 21) is provided with container restrainers 81, 82, and 83 for removably holding the hermetically sealed container 10. The container restrainers 81, 82, and 83 are configured to restrain the hermetically sealed container 10 from the Y1-direction side, the Y2-direction side, and the X1-direction side, respectively, and is configured to be elastically deformable. The container restrainer 81, 82 and 83 includes, for example, a plate spring.

The lid 12 of the hermetically sealed container 10 in which the measuring unit 40 is accommodated is configured such that a communication cable 43 for transmitting the detection signal of the measuring unit 40 (the temperature sensor 41 and the humidity sensor 42) to the outside can pass therethrough. The communication cable 43 is connected to the temperature adjuster 30 and a display unit, not shown, for displaying the temperature in the hermetically sealed container 10.

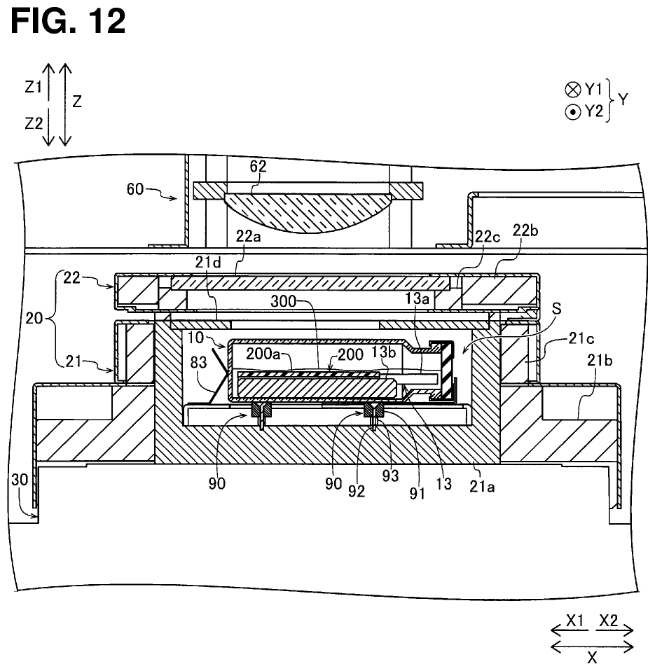

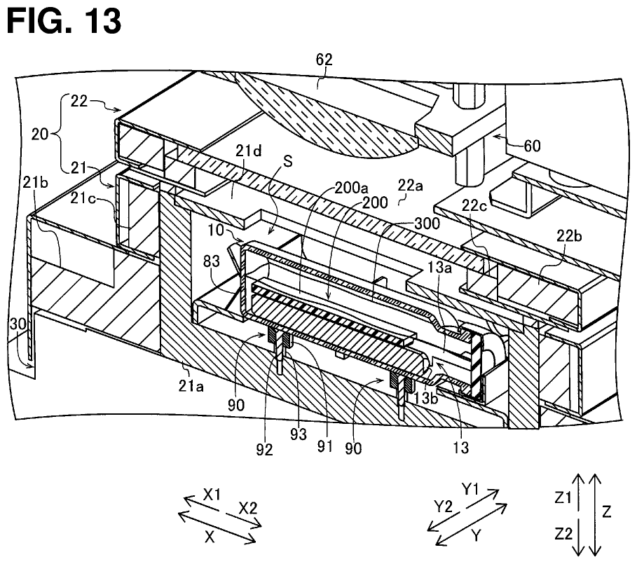

Further, as shown in FIG. 12 and FIG. 13, the container holder 20 is provided with a sample surface adjuster 90 for adjusting the inclination of the surface of the sample 200 with respect to the irradiation direction such that the surface 200a of the sample 200 in the hermetically sealed container 10 becomes perpendicular to the direction (Z-direction) along the light emitted from the irradiation unit 60. Note that the sample surface adjuster 90 is provided for each hermetically sealed container 10.

The sample surface adjuster 90 includes a magnet 91 provided on the side (Z2-direction side) where the irradiation unit 60 is arranged with respect to the hermetically sealed container 10. The sample surface adjuster 90 is provided with a screw 92 for attaching the magnet 91 to the aluminum block 21a (accommodation unit 21) and a spacer 93 for adjusting the height position (position in the Z-direction) of the magnet 91.

The sample support 13 including the magnetic rod 13b, which is a ferromagnetic member, is attracted to the magnet 91, so that the surface 200a of the sample 200 in the hermetically sealed container 10 becomes perpendicular to the direction along the irradiation direction (in the Z-direction). Specifically, the magnetic rod 13b is held, and the support plate 13a (see FIG. 9) having a U-shape when viewed from the X1-direction side is attracted to the magnet 91 by the magnetic rod 13b, so that the surface 200a of the sample 200 is adjusted to be convex on the Z1-direction side (toward the irradiation unit 60) when viewed from the X1-direction side within the hermetically sealed container 10.

(Effects of this Embodiment)

In this embodiment, the following effects can be obtained.

In this embodiment, it is configured to conduct an accelerated degradation test of the sample 200 accommodated in a hermetically sealed state in the hermetically sealed container 10 in a state in which the sample 200 is accommodated in the hermetically sealed container 10 together with the liquid 300 as one of degradation factors. With this, in an accelerated degradation test in which degradation of the sample 200 is accelerated by multiple degradation factors, it is possible to conduct the test in a state in which the sample is in contact with the liquid in the hermetically sealed container 10 by accommodating the liquid 300 as one degradation factor together with the sample 200 in the hermetically sealed container 10. As a result, unlike the case in which a liquid 300 is spayed against the sample 200, it is not necessary to adjust the test environment to accelerate the degradation by means of the liquid, and therefore, it is possible to easily accelerate the degradation by means of the liquid 300. With this, in the accelerated degradation test in which degradation of the sample 200 is accelerated by multiple degradation factors, it is possible to easily accelerate the degradation by means of the liquid 300 (in a solution environment).

Further, in the above-described accelerated degradation testing device 100 according to the embodiment, the following further effects can be obtained by configuring as follows.

Further, in this embodiment, the hermetically sealed container 10 includes the bottle-shaped container body 11 in which the sample 200 is accommodated and the lid 12 (sealing portion) for hermetically sealing the container body 11 in a state in which the sample 200 is accommodated in the container body 11. With this, it is possible to conduct the accelerated degradation test of the sample 200 accommodated in the container body 11 (hermetically sealed container 10) together with the liquid 300 in a state in which the container body 11 of the hermetically sealed container 10 is hermetically sealed by the lid 12.

Further, in this embodiment, the accelerated degradation testing device 100 is equipped with the temperature adjuster 30 for adjusting the temperature as one of degradation factors and the measuring unit 40 (container internal environment measuring unit) for measuring the environment including within the hermetically sealed container 10. And it is configured such that the accelerated degradation test of the sample 200 hermetically sealed in the hermetically sealed container 10 is conducted by adjusting the temperature by the temperature adjuster 30 in a state in which the sample 200 is accommodated in the hermetically sealed container 10. With this, the degradation due to the temperature (heat) of the sample 200 can be accelerated by adjusting the temperature by the temperature adjuster 30. Further, the measuring unit 40 measures the environment including the temperature in the hermetically sealed container 10, so the temperature adjustment by the temperature adjuster 30 can be performed with high accuracy.

Further, in this embodiment, there is provided with a plurality of hermetically sealed containers 10. Further, the measuring unit 40 (container internal environment measuring unit) includes the temperature sensor 41 to be accommodated in the hermetically sealed container 10 in a hermetically sealed state. The container holder 20 is configured to hold the hermetically sealed container 10 in which the temperature sensor 41 is hermetically accommodated in place of the sample 200, along with the hermetically sealed container 10 in which the sample 200 is sealed in a hermetically sealed state. With this, the temperature sensor 41 is accommodated in the hermetically sealed state in the hermetically sealed container 10 in the same manner as the sample 200, so that the temperature change around the sample 200 in the hermetically sealed container 10 can be accurately measured.

Further, in this embodiment, it is configured such that a plurality of hermetically sealed containers 10 each accommodating the sample 200 in a hermetically sealed state is accommodated in the accommodation unit 21, and the hermetically sealed container 10 in which the temperature sensor 41 is accommodated instead of the sample 200 in the hermetically sealed state is accommodated in the accommodation unit 21. With this, the accelerated degradation test can be conducted in a state in which different samples 200 are accommodated in the plurality of hermetically sealed containers 10, so that accelerated degradation tests of the different samples 200 can be conducted at the same time. Further, accelerated degradation tests can be conducted in a state in which different liquids 300 are accommodated in a plurality of hermetically sealed containers 10 accommodating the same sample 200, and therefore, accelerated degradation tests with different degradation factors (liquids 300) can be conducted simultaneously for the same sample 200.

Further, in this embodiment, the accelerated degradation testing device 100 is further equipped with an irradiation unit 60 that emits light as one of degradation factors. Note that the container body 11 is a translucent member. The accelerated degradation test of the sample 200, which is hermetically sealed in the hermetically sealed container 10, is conducted by irradiating the sample 200 with the light emitted from the irradiation unit 60 through the container body 11, and therefore, the accelerated degradation test of the sample 200, which is accommodated in the hermetically sealed container 10 in a hermetically sealed state, is conducted. With this, the degradation of the sample 200 due to light can be accelerated by the light emitted from the irradiation unit 60 through the translucent container body 11.

Further, in this embodiment, the accelerated degradation testing device 100 is equipped with a light source 50 that emits light as a degradation factor. The irradiation unit 60 is configured to branch the light emitted from the light source 50 and irradiate each of the samples 200 in the plurality of hermetically sealed containers 10 held by the container holder 20 with the light. Here, in cases where the intensity of the light emitted by the light source 50 is low, the sample 200 located away from the center of the irradiation region cannot be irradiated with light of the intensity necessary for degradation, and the acceleration (promotion) of degradation by the light may vary due to the position of the hermetically sealed container 10 within the container holder 20. However, in this embodiment, as described above, it is configured to emit light for each of the samples 200 of the plurality of hermetically sealed containers 10 held in the container holder 20. Therefore, unlike the case where light is emitted for the plurality of hermetically sealed containers 10 collectively, it is possible to emit light evenly for each of the samples 200 of the plurality of hermetically sealed containers 10. As a result, even in cases where the intensity of light emitted by the light source 50 is low, the intensity of light emitted to each of the samples 200 accommodated in the plurality of hermetically sealed containers 10 can be ensured, regardless of the position of the hermetically sealed container 10 within the container holder 20. With this, it is possible to control the variation in the acceleration (promotion) of light-induced degradation due to the position of the hermetically sealed container 10 within the container holder 20.

Further, in this embodiment, the irradiation unit 60 includes a lens 62 (diaphragm) that narrows the light irradiation region to correspond to the location of the sample 200 in the hermetically sealed container 10. With this, the irradiation region of the light is narrowed down according to the location where the sample 200 is arranged, so that the light can be emitted to the sample 200 efficiently.

Further, in this embodiment, there is provided with the sample surface adjuster 90 that adjusts the inclination of the surface 200a of the sample 200 with respect to the irradiation direction so that the surface 200a of the sample 200 in the hermetically sealed container 10 becomes perpendicular to the direction (Z-direction) along the irradiation direction of the light emitted by the irradiation unit 60. With this, the light can be directed perpendicularly to the surface 200a of the sample 200 in the hermetically sealed container 10, and therefore, the light-induced degradation of the sample 200 can be accelerated with high precision.

Further, in this embodiment, the accelerated degradation testing device 100 is equipped with the sample support 13 that supports the sample 200 in the hermetically sealed container 10 together with the magnetic rod 13b (including a ferromagnetic member). Furthermore, the sample surface adjuster 90 is equipped with the magnet 91 provided on the side opposite to the side where the irradiation unit 60 is arranged with respect to the hermetically sealed container 10. And, it is configured such that the sample support 13 including the magnetic rod 13b is attracted to the magnet 91, so that the surface 200a of the sample 200 in the hermetically sealed container 10 becomes perpendicular to the direction along the irradiation direction (Z-direction). With this, even in cases where the inclination of the surface 200a of the sample 200 with respect to the irradiation direction is not perpendicular to the direction along the irradiation direction (Z-direction) of the light emitted by the irradiation unit 60 when the sample support 13 holds the hermetically sealed container 10, the magnetic force will cause the sample support 13 including the magnetic rod 13b to be moved so that the surface 200a of the sample 200 becomes perpendicular to the direction along the irradiation direction (Z-direction) of the light emitted by the irradiation unit 60. As a result, the surface 200a of the sample 200 in the hermetically sealed container 10 becomes perpendicular to the direction (Z-direction) along the irradiation direction, so that it is possible to irradiate the surface 200a of the sample 200 in the hermetically sealed container 10 with the light with high precision.

Further, in this embodiment, the sample support 13 is configured to support the sample 200 in the hermetically sealed container 10 and is configured to be taken out from the inside of the hermetically sealed container 10. With this, the user can place the sample 200 on the sample support 13 taken out of the inside of the hermetically sealed container 10, which makes it easy for the user to make the sample support 13 support the sample 200.

Further, in this embodiment, the hermetically sealed container 10 is a sampling container used for an analysis by a gas chromatography analyzer. With this, the hermetically sealed container 10 taken out of the container holder 20 can be used for an analysis by a gas chromatograph analyzer as it is, so the sample 200 subjected to the accelerated degradation test can be easily analyzed by the gas chromatograph analyzer.

### <Modifications>

Note that the embodiments disclosed here should be considered illustrative and not restrictive in all respects. It should be noted that the scope of the present invention is indicated by claims and is intended to include all modifications (modified examples) within the meaning and scope of the claims and equivalents.

For example, in the above-described embodiment, an example is shown in which the accelerated degradation testing device 100 accelerates the degradation of the sample 200 due to the temperature (heat) caused by the temperature adjustment by the temperature adjuster 30 and the degradation of the sample 200 due to the light emitted from the irradiation unit 60. In the present invention, the accelerated degradation testing device may be configured to accelerate only one of the following: the acceleration of degradation of the sample due to the temperature (heat) caused by the temperature adjustment by the temperature control unit, and the acceleration of degradation of the sample due to the light emitted by the irradiation unit.

Further, in the above-described embodiment, an example is shown in which the temperature adjuster 30 includes a hot plate to raise the temperature of the air surrounding the hermetically sealed container 10, but the invention is not limited thereto. In the present invention, the temperature adjuster may be configured to cool the air surrounding the hermetically sealed container.

Further, in the above-described embodiment, an example is shown in which three hermetically sealed containers 10 are provided, but the present invention is not limited thereto. In the present invention, the number of hermetically sealed containers may be two or less, or four or more.

Further, in the above-described embodiment, an example is shown in which the temperature sensor 41 is accommodated in the hermetically sealed container 10 in a hermetically sealed state, but the present invention is not limited thereto. In the present invention, the accelerated degradation testing device may be configured to measure the ambient temperature of the hermetically sealed container without accommodating a temperature sensor in the hermetically sealed container. For example, the accelerated degradation testing device may be configured to measure the temperature of the sample in a hermetically sealed container by acquiring infrared radiation emitted from the sample from the outside of the hermetically sealed container.

Further, in the above-described embodiment, an example is shown in which a plurality of hermetically sealed containers 10 each hermetically sealing a sample 200 is accommodated in the accommodation unit 21, and a hermetically sealed container 10 accommodating the temperature sensor 41 in place of the sample 200 is accommodated in the accommodation unit 21, but the present invention is not limited thereto. In the present invention, a single hermetically sealed container accommodating a sample in a hermetically sealed state and a single hermetically sealed container accommodating a temperature sensor (measuring unit) instead of a sample may be accommodated in the housing unit (container holder).

Further, in the above-described embodiment, an example is shown in which the irradiation unit 60 is configured to branch the light emitted from the light source 50 and irradiate each sample 200 of a plurality of hermetically sealed containers 10 held by the container holder 20 with the light, but the present invention is not limited thereto. In the present invention, the irradiation unit may collectively emit the light emitted from the light source to a plurality of hermetically sealed containers. The accelerated degradation testing device may be configured to include a shutter (light-shielding section) in the irradiation unit or the container holder, so that light irradiation can be switched on and off for each sealed container.

Further, in the above-described embodiment, an example is shown in which the irradiation unit 60 is configured to include the lens 62 (diaphragm) that narrows the light irradiation region to correspond to the location of the sample 200 in the hermetically sealed container 10, but the present invention is not limited thereto. In the present invention, the irradiation unit may emit light to the sample without narrowing the light irradiation region.

Further, in the above-described embodiment, an example is shown in which the sample surface adjuster 90 is provided to adjust the inclination of the surface 200a of the sample 200 with respect to the irradiation direction, but the present invention is not limited thereto. In the present invention, it may be configured such that the user adjusts the inclination of the surface of the sample with respect to the light irradiation direction without providing a sample surface adjuster.

Further, in the above-described embodiment, an example is shown in which the sample support 13 including the magnetic rod 13b (ferromagnetic member) is attracted to the magnet 91 so that the surface 200a of the sample 200 in the hermetically sealed container 10 becomes perpendicular to the direction along the irradiation direction (Z-direction), but the present invention is not limited thereto. In the present invention, it may be configured such that a ferromagnetic member is arranged outside the hermetically sealed container 10 and that the sample support includes a magnet.

Further, in the above-described embodiment, an example is shown in which the sample support 13 including the magnetic rod 13b (ferromagnetic member) accommodated within the hermetically sealed container 10 is attracted to the magnet 91, so that the surface 200a of the sample 200 in the hermetically sealed container 10 becomes perpendicular to the direction (Z-direction) along the irradiation direction, but the present invention is not limited thereto. In the present invention, a ferromagnetic member may be provided on the outer wall surface of the hermetically sealed container (container body).

Further, in the above-described embodiment, an example is shown in which the sample support 13 is configured to support the sample 200 in the hermetically sealed container 10 and is configured to be taken out of the inside of the hermetically sealed container 10, but the present invention is not limited thereto. In the present invention, the sample support may be fixed within the hermetically sealed container.

Further, in the above-described embodiment, an example is shown in which the hermetically sealed container 10 is a sampling container used for an analysis by a gas chromatograph analyzer, but the present invention is not limited thereto. In the present invention, the hermetically sealed container may be a dedicated container for accelerated degradation testing devices.

### [Aspects]

It would be understood by those skilled in the art that the exemplary embodiments described above are specific examples of the following aspects.

### (Item 1)

An accelerated degradation testing device for an accelerated degradation test in which degradation of a sample as a test target is accelerated by means of multiple degradation factors that degrade the sample, the accelerated degradation testing device comprising:
a hermetically sealed container capable of accommodating the sample as a target of the accelerated degradation test in a hermetically sealed state; and
a container holder configured to hold the hermetically sealed container,
wherein the accelerated degradation test of the sample accommodated in the hermetically sealed container in a hermetically sealed state is conducted in a state in which the sample is accommodated in the hermetically sealed container together with a liquid as one of the degradation factors.

### (Item 2)

The accelerated degradation testing device as recited in the above-described Item 1,
wherein the hermetically sealed container includes a bottle-shaped container body for accommodating the sample and a sealing portion for sealing the container body in a state in which the sample is accommodated in the container body.

### (Item 3)

The accelerated degradation testing device as recited in the above-described Item 2, further comprising:
a temperature adjuster configured to adjust a temperature as one of the degradation factors; and
a container internal environment measuring unit configured to measure an environment in the hermetically sealed container, the environment including a temperature,
wherein the accelerated degradation test of the sample accommodated in the hermetically sealed container in a hermetically sealed state is conducted by performing a temperature adjustment by the temperature adjuster in a state in which the sample is accommodated in the hermetically sealed container.

### (Item 4)

The accelerated degradation testing device as recited in the above-described Item 3,
wherein a plurality of the hermetically sealed containers is provided,
wherein the container internal environment measuring unit includes a temperature sensor to be accommodated in the hermetically sealed container in the hermetically sealed state, and
wherein the container holder is configured to hold the hermetically sealed container in which the temperature sensor is accommodated instead of a sample in a hermetically sealed state, together with the hermetically sealed container in which the sample is accommodated in a hermetically sealed state.

### (Item 5)

The accelerated degradation testing device as recited in the above-described Item 4,
wherein the container holder includes an accommodation unit for accommodating the hermetically sealed containers, and is configured to accommodate a plurality of the hermetically sealed containers each accommodating the sample in the accommodation unit in a hermetically sealed state and accommodate the hermetically sealed container accommodating a temperature sensor instead of the sample in a hermetically sealed state in the accommodation unit.

### (Item 6)

The accelerated degradation testing device as recited in any one of the above-described Items 2 to 5, further comprising:
an irradiation unit configured to emit light as one of the degradation factors,
wherein the container body is a translucent member, and
wherein the sample is irradiated via the container body with the light emitted from the irradiation unit in a state in which the sample is accommodated in the hermetically sealed container to conduct the accelerated degradation test on the sample accommodated in the hermetically sealed container in a hermetically sealed state.

### (Item 7)

The accelerated degradation testing device as recited in the above-described Item 6, further comprising:
a light source configured to emit light as one of the degradation factors,
wherein the irradiation unit is configured to branch the light emitted from the light source and irradiate each of the samples in a plurality of the hermetically sealed containers held by the container holder with the light.

### (Item 8)

The accelerated degradation testing device as recited in the above-described Item 7,
wherein the irradiation unit includes a diaphragm for narrowing a light irradiation region to correspond to a location of the sample in the hermetically sealed container.

### (Item 9)

The accelerated degradation testing device as recited in any one of the above-described Items 6 to 8, further comprising:
a sample surface adjuster configured to adjust an inclination of a surface of the sample in the hermetically sealed container with respect to an irradiation direction of the light emitted by the irradiation unit so that the surface of the sample in the hermetically sealed container becomes perpendicular to the irradiation direction.

### (Item 10)

The accelerated degradation testing device as recited in the above-described Item 9, further comprising:
a sample support 13 including a ferromagnetic member, the sample support being configured to support the sample in the hermetically sealed container,
wherein the sample surface adjuster includes a magnet provided on a side of the hermetically sealed container opposite to a side on which the irradiation unit is arranged, and
wherein the sample support including the ferromagnetic member is attracted to the magnet so that the surface of the sample in the hermetically sealed container becomes perpendicular to a direction along the irradiation direction.

### (Item 11)

The accelerated degradation testing device as recited in the above-described Item 10,
wherein the sample support is configured to support the sample in the hermetically sealed container and be capable of being taken out of the hermetically sealed container.

### (Item 12)

The accelerated degradation testing device as recited in any one of the above-described Items 1 to 11,
wherein the hermetically sealed container is a sampling container used for an analysis by a gas chromatograph analyzer.

### DESCRIPTION OF REFERENCE SYMBOLS

10: Hermetically sealed container
11: Container body
12: Lid (Sealing portion)
13: Sample support
13b: Magnetic rod (ferromagnetic member)
20: Container holder
21: Accommodation unit
30: Temperature adjuster
40: Measuring unit (Container internal environment measuring unit)
41: Temperature sensor
50: Light source
60: Irradiation unit
62: Lens (Diaphragm)
90: Sample surface adjuster
91: Magnet
100: Accelerated degradation testing device
200: Sample
200a: Surface (of sample)
300: Liquid

1. An accelerated degradation testing device for an accelerated degradation test in which degradation of a sample as a test target is accelerated by means of multiple degradation factors that degrade the sample, the accelerated degradation testing device comprising:
a hermetically sealed container capable of accommodating the sample as a target of the accelerated degradation test in a hermetically sealed state, the hermetically sealed container being used as a sampling container for an analyzer for performing an analysis by extracting a content via a lid; and
a container holder configured to hold the hermetically sealed container,
wherein the accelerated degradation test of the sample accommodated in the hermetically sealed container in a hermetically sealed state is conducted in a state in which the sample is accommodated in the hermetically sealed container together with a liquid as one of the degradation factors.

2. The accelerated degradation testing device as recited in claim 1,
wherein the hermetically sealed container includes a bottle-shaped container body for accommodating the sample and a sealing portion for sealing the container body in a state in which the sample is accommodated in the container body.

3. The accelerated degradation testing device as recited in claim 2, further comprising:
a temperature adjuster configured to adjust a temperature as one of the degradation factors; and
a container internal environment measuring unit configured to measure an environment in the hermetically sealed container, the environment including a temperature,
wherein the accelerated degradation test of the sample accommodated in the hermetically sealed container in a hermetically sealed state is conducted by performing a temperature adjustment by the temperature adjuster in a state in which the sample is accommodated in the hermetically sealed container.

4. The accelerated degradation testing device as recited in claim 3,
wherein a plurality of the hermetically sealed containers is provided,
wherein the container internal environment measuring unit includes a temperature sensor to be accommodated in the hermetically sealed container in the hermetically sealed state, and
wherein the container holder is configured to hold the hermetically sealed container in which the temperature sensor is accommodated instead of a sample in a hermetically sealed state, together with the hermetically sealed container in which the sample is accommodated in a hermetically sealed state.

5. The accelerated degradation testing device as recited in claim 4,
wherein the container holder includes an accommodation unit for accommodating the hermetically sealed containers, and is configured to accommodate a plurality of the hermetically sealed containers each accommodating the sample in the accommodation unit in a hermetically sealed state and accommodate the hermetically sealed container accommodating a temperature sensor instead of the sample in a hermetically sealed state in the accommodation unit.

6. The accelerated degradation testing device as recited in claim 2, further comprising:
an irradiation unit configured to emit light as one of the degradation factors,
wherein the container body is a translucent member, and
wherein the sample is irradiated via the container body with the light emitted from the irradiation unit in a state in which the sample is accommodated in the hermetically sealed container to conduct the accelerated degradation test on the sample accommodated in the hermetically sealed container in a hermetically sealed state.

7. The accelerated degradation testing device as recited in claim 6, further comprising:
a light source configured to emit light as one of the degradation factors,
wherein the irradiation unit is configured to branch the light emitted from the light source and irradiate each of the samples in a plurality of the hermetically sealed containers held by the container holder with the light.

8. The accelerated degradation testing device as recited in claim 6,
wherein the irradiation unit includes a diaphragm for narrowing a light irradiation region to correspond to a location of the sample in the hermetically sealed container.

9. The accelerated degradation testing device as recited in claim 6, further comprising:
a sample surface adjuster configured to adjust an inclination of a surface of the sample in the hermetically sealed container with respect to an irradiation direction of the light emitted by the irradiation unit so that the surface of the sample in the hermetically sealed container becomes perpendicular to the irradiation direction.

10. The accelerated degradation testing device as recited in claim 9, further comprising:
a sample support including a ferromagnetic member, the sample support being configured to support the sample in the hermetically sealed container,
wherein the sample surface adjuster includes a magnet provided on a side of the hermetically sealed container opposite to a side on which the irradiation unit is arranged, and
wherein the sample support including the ferromagnetic member is attracted to the magnet so that the surface of the sample in the hermetically sealed container becomes perpendicular to a direction along the irradiation direction.

11. The accelerated degradation testing device as recited in claim 10,
wherein the sample support is configured to support the sample in the hermetically sealed container and be capable of being taken out of the hermetically sealed container.

12. The accelerated degradation testing device as recited in claim 1,
wherein the hermetically sealed container is a sampling container used for an analysis by a gas chromatograph analyzer.
